(19) United States
(12) Patent Application Publication
(10) Pub. No.: US 2019/0303998 A1
(43) Pub. Date: Oct. 3, 2019

(54) Online Platform for Interaction with Influencers

(71) Applicants: Rahul Patil, Libertyville, IL (US); Bharti Patil, Libertyville, IL (US)

(72) Inventors: Rahul Patil, Libertyville, IL (US); Bharti Patil, Libertyville, IL (US)

(21) Appl. No.: 16/358,960

(22) Filed: Mar. 20, 2019

Related U.S. Application Data
(60) Provisional application No. 62/651,069, filed on Mar. 30, 2018.

(51) Int. Cl. G06Q 30/06; G06Q 30/02; G06Q 50/00

(52) U.S. Cl. CPC G06Q 30/0631; G06Q 50/01; G06Q 30/0201; G06Q 30/0226

(57) ABSTRACT

Apparatus and methods related to an online platform for influencers are provided. A system can receive, via a network, at an online platform hosting a plurality of community pages respectively associated with influential individuals, an access request from a first user to access the online platform, where each community page is associated with a respective influential individual, and where the respective community page comprises a listing of items and services provided by the respective influential individual. In response to providing access to the first user, the system can receive from the first user, via the network, an information request. And based on the information request, the system can provide, via the network, the information to the first user.

### CROSS-REFERENCE TO RELATED APPLICATIONS

The present application is a non-provisional patent application claiming priority to Provisional Patent Application No. 62/651,069, filed Mar. 30, 2018, the contents of which are hereby incorporated by reference.

### BACKGROUND

The Internet has revolutionized various aspects of daily life, such as communication and financial transactions. One area in particular that the Internet has drastically changed is commerce. The Internet has not only revolutionized commerce for consumers but has also revolutionized the market for sellers. For instance, the Internet has made it possible for sellers to sell and market their products and services to consumers on a global scale. To assist with this broadening market, sellers often recruit influential individuals (also referred to as influencers) to endorse products to consumers. Typically, these endorsed products are sold on a seller's website and/or other commerce websites. In addition to products endorsed by the influencers, some online sellers also sell items that have been personalized by influencers. For example, some sellers sell sports memorabilia that have been signed by sports figures associated with the items.

However, a buyer that is seeking to buy products endorsed or personalized by influencers often faces various obstacles in obtaining such products. First, products that are endorsed by influencers are often not organized as such on e-commerce websites. Rather, such items are typically categorized on websites by an item type (e.g., electronics), and thus, a buyer has to search through all of the items of a particular category in order to find the desired endorsed product. As for personalized items, such items are usually available in very limited quantities, if available at all. Also, usually personalized items that are for sale have already been personalized by an influencer for an individual who obtained the item from the influencer. As a result, the market usually only has products that have been personalized for someone other than the purchaser.

### SUMMARY

In one aspect, a system is described. The system includes at least one processor and executable instructions accessible on a computer-readable medium that, when executed, cause the at least one processor to perform operations including: receiving, via a network, at an online platform hosting a plurality of community pages respectively associated with influential individuals, an access request from a first user to access the online platform, where each community page is associated with a respective influential individual, and wherein the respective community page includes a listing of items and services provided by the respective influential individual. The operations also include in response to providing access to the first user, receiving from the first user, via the network, an information request. Further, the operations include based on the information request, providing, via the network, the information to the first user.

In another aspect, a method is provided. The method includes receiving, via a network device, at an online platform hosting a plurality of community pages respectively associated with influential individuals, a gift recommendation request from a first user for a targeted recipient, where each community page is associated with a respective influential individual, and where the respective community page comprises a listing of items and services provided by the respective influential individual. The method also includes based on social media data retrieved from social media pages of the targeted recipient, generating a gift recommendation for the targeted recipient.

In yet another aspect, a method is provided. The method includes receiving, via a network device, at an online platform hosting a plurality of community pages respectively associated with influential individuals, a request for analytical data for a first community page that is associated with a first influential individual. The method also includes in response to receiving the request, generating analytical data comprising sales data of the items and services provided on the first community page. The method further includes based on the analytical data, determining an influence of the first influential individual.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE FIGURES

FIG. 1 depicts a simplified block diagram of an ecosystem of an online platform for influencers, according to an example embodiment.

FIG. 2 illustrates a web page accessing an online platform for influencers, according to an example embodiment.

FIG. 3 illustrates a graphical user interface (GUI) of a computing device application accessing an online platform for influencers, according to an example embodiment.

FIGS. 4A, 4B, 4C, 4D, 4E, 4F, 4G, and 4H each illustrate a GUI of an online platform for influencers, according to example embodiments.

FIG. 5 depicts a simplified block diagram of an ecosystem of an online platform for influencers, according to an example embodiment.

FIG. 6 depicts a distributed computing architecture, in accordance with at least some example embodiments.

FIG. 7 is a functional block diagram of computing device 700, in accordance with at least some example embodiments

FIGS. 8A, 8B, 8C, and 8D each illustrate a GUI of an online platform for influencers, according to example embodiments.

### DETAILED DESCRIPTION

Exemplary methods and systems are described herein. It should be understood that the word “exemplary” is used herein to mean “serving as an example, instance, or illustration.” Any implementation or feature described herein as “exemplary” or “illustrative” is not necessarily to be construed as preferred or advantageous over other implementations or features. In the figures, similar symbols typically identify similar components, unless context dictates otherwise. The example implementations described herein are not meant to be limiting. It will be readily understood that the aspects of the present disclosure, as generally described herein, and illustrated in the figures, can be arranged, substituted, combined, separated, and designed in a wide variety of different configurations, all of which are contemplated herein.

### I. Overview

Buying a gift for a loved one or for one's self on a special occasion, such as Barmitswa, Batmetswa, birthdays (e.g., sweet sixteen), milestone anniversaries, weddings, among other special occasions, is often challenging since it can be difficult to find gifts that are not only meaningful, but that can also create lifelong memories. It is commonly known that a giftee would appreciate a gift that is associated with an influential person (e.g., a celebrity) that giftee admires. More so, a gift that has been personalized by the influential individual is a meaningful gift that would create a lifelong memory and experience for the giftee. However, such personalized gifts are difficult to acquire since the average person does not have access to influential individuals to request personalized gifts. Thus, the person purchasing the gift often settles for buying a second-hand gift that may have been personalized by the influential individual for a person other than the giftee. Although this gift is unique, it is not as unique as a gift that has been personalized specifically for the giftee.

However, there can be obstacles to buying a personalized gift. First, the average individual may not know the best type of personalized products or services that a giftee would appreciate or find memorable. It would be helpful for individuals to obtain suggestions and/or recommendations on unique gift ideas. Second, influencers have no direct channel to access an average person across the globe to promote all the product and customizable services and perform commercial transactions. As such, a reliable and efficient platform on which individuals can purchase personalized products and services does not exist.

Disclosed herein is a centralized platform that can connect influential individuals (also called tribe leaders or influencers) to the general public generally, with their followers or fans specifically. On the platform, an influential individual can manage a personalized page that can be joined by their fans (also called tribe members or followers). On the personalized page, the influencer can list products for sale, such as personalized products (e.g., (i) autographed products, (ii) virtual products such as videos, sound media, and images, and (iii) personal items from the leader's collection, etc.) and products endorsed by the influencer. Additionally, the influencer can list different personalized gifts that the influencer is willing to create or provide.

In an embodiment, the platform can help an individual purchase a unique gift for a tribe member. In particular, the platform allows the third-party to browse items that are associated with influencers that the tribe member follows and/or to request personalized gifts from the influencers. The platform can filter the different gifts and services based on price range, availability, approximate delivery time, product reviews, among other filters.

In an embodiment, the platform can also provide an individual with a gift recommendation for a particular tribe member, a platform user, or other individual or guest. After the individual provides the tribe member's identifying information (e.g., social media profile, full name, etc.), the platform can generate a gift recommendation for the tribe member. In an example, the gift recommendation can be based on the tribes in which the tribe member is a member, social media activity of the tribe member, among other factors. In another example, the platform can generate more than one gift recommendation for a user. Then, the platform can filter different gift recommendations based on price range, availability, approximate delivery time, and product reviews. Thus, the individual can quickly find a suitable and unique gift from the marketplace for the tribe member. In some embodiments, the platform may generate an output (e.g., based on the individual's selection) that causes a gift (e.g., a personalized item) to be packaged and or shipped (e.g., shipped to the giftee). Additionally or alternatively, the platform may generate an output (e.g., a notification message) that causes the influencer to take a specific action (e.g., attend a specified event, personalize a specified item, sign a specified piece of memorabilia, etc.). Further, the platform may generate an output (e.g., a request message) that causes an organizer to organize an event (e.g., reserve a venue for a concert performance of the influencer). Even further, the platform may display (e.g., an image) or play (e.g., a sound clip) a personalized piece of content to the individual. For example, a recorded video from the influencer that wishes the individual a happy anniversary may be played using the platform.

This centralized platform can be beneficial to both an influencer and a tribe member (or other platform user or guest). For an influencer, the platform can provide the influencer with a portal on which the influencer can manage both business endeavors and interactions with fans. The platform can also provide the influencer with valuable market data on products endorsed by the influencer. Such data can provide the influencer with data to negotiate endorsements with companies whose product the influencer endorses and/or companies that are seeking endorsement from the influencer.

As for tribe members, the platform can function as a portal on which tribe members can interact with all of the influencers that they are interested in following. In particular, on this platform, the tribe member can (i) read updates from all of the social media accounts of an influencer, (ii) buy products endorsed or customized by an influencer, and (iii) interact with an influencer by either writing them a message or by requesting them to attend a particular event (either a business or personal event).

Additionally, the platform can be a source of valuable marketing data for companies that have an endorsement contract with an influencer and/or for companies that are seeking endorsement from the influencer. Specifically, a company can determine how much of a particular endorsed product an influencer is selling on the platform or via links listed on the platform. Such sales data can be valuable during contract negotiations between the influencer and the company. Additionally, a company seeking an influencer for an endorsement can use the platform to obtain data indicative of how much of a similar product the leader has sold via the platform. Additionally and/or alternatively, the company can determine how much influence an influencer has in a particular country based on the influencer's sales numbers in the particular country. Still further, the company seeking the endorsement from the influencer may generate content (e.g., produce and record a television commercial) based on the marketing data. Even further, the company may use the marketing data to decide which types of merchandise to stock and in what quantities. For example, the platform may send an alert to the company that causes the company to restock (e.g., a warehouse or a physical storefront) merchandise of a specified type and/or endorsed by a specified influencer.

### II. Example Ecosystem of the Online Platform for Influencers

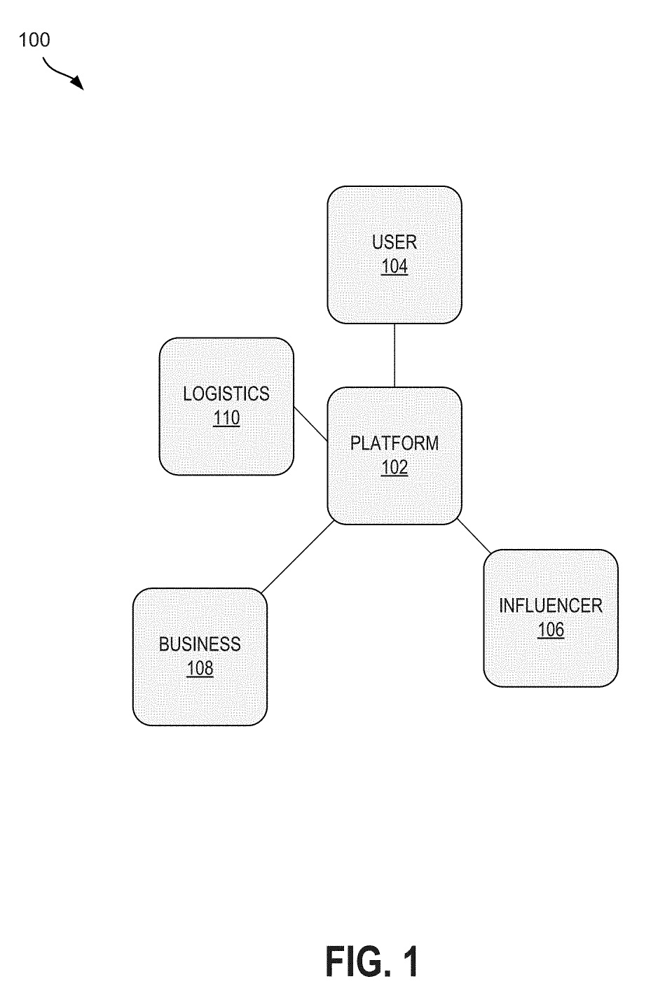

FIG. 1 illustrates an ecosystem 100 of a platform 102 for influencers, according to an example embodiment. The platform 102 can be software that operates on one or more computing devices, such as one or more server computing devices (not shown in FIG. 1). In some embodiments, the platform 102 can be implemented as a “cloud-based” service on Internet servers. As such, the platform 102 can be accessed via web pages and/or software applications that can be installed on computing devices (e.g., mobile devices).

In line with the discussion above, influencers can create on the platform 102 personalized sites that can be joined by fans of the influencers. By creating a personalized site, influencers are creating virtual “tribes” that can be joined by “tribe members” and that are managed by influencers or “tribe leaders.” Notably, personalized sites on the platform 102 allow influencers to manage both their business endeavors and interactions with tribe members that are part of the tribes that are managed by the influencers.

As illustrated in FIG. 1, an influencer 106 can access the platform 102, perhaps via a computing device (not illustrated in FIG. 1). In an embodiment, the influencer 106 can access the platform 102 in order to create a personalized site or tribe on the platform 102. In one example, the influencer 106 can be invited to sign up by an administrator of the platform 102, perhaps through an invitation sent through email or some other electronic communication means. In another example, the influencer 106 can request to sign up as an influencer on the platform 102. In this embodiment, the administrator of the platform 102 can request identifying documentation from the influencer 106 in order to confirm the identity of the influencer 106. Once the identity of the influencer 106 has been verified, then the influencer 106 can be allowed to sign up as an influencer on the platform 102.

Once the influencer 106 has signed up with the platform 102, the influencer 106 can access an influencer interface. This interface can only accessed by the influencer 106 or a person working on behalf of the influencer 106. Using this interface, the influencer 106 can create and manage a personalized site that can be accessed by a user 102 of the platform 102. Within examples, the interface can include tools that can assist the influencer 106 with creating the personalized site, perhaps by providing design templates, site design tools, and/or by providing access to site designers that are employed or contracted by the administrator of the platform 102.

Within examples, a personalized site can include a news feed, a social media feed, a messaging interface, among other features. The news feed can include news articles that are about the influencer 106 or that mention the influencer 106. The news feed can retrieve news automatically from online resources. Additionally and/or alternatively, news articles or other status updates can be posted in the news feed by the influencer 106. The social media feed can include social media posts made by the influencer 106 on various social media platforms. And the messaging interface can be used to exchange messages (e.g., audio or text) between the influencer 106 and patrons of the influencer 106's personalized site.

In an embodiment, the personalized site can also include a marketplace that includes items or services for sale by the influencer 106. The items that are for sale can include products that the influencer 106 endorses. Additionally and/or alternatively, the marketplace can include personalized items or services for sale by the influencer 106. Personalized items can include items that can be personalized for or addressed to a specific person. And services provided by the influential individual can include personalized messages (e.g., audio, video, and/or text) created by the influential individual for a particular person. The services can also include appearances by the influencer 106 to an event for a particular person. For instance, the influencer 106 can make an appearance at a birthday party for the particular person. Other examples of items and services are also possible.

In an embodiment, the ecosystem 100 can include logistics 110. The logistics 110 can include resources such as human resources, products, computing resources, etc. The influencer 106 can use the logistics 110 to perform various functions that are necessary for proper functioning of the platform 102. Generally, the logistics 110 can perform functions that involve the management of resources, how products are obtained (e.g., vendor, inventory management), stored (e.g., storage locations), and shipped (e.g., shipping method, tracking numbers, etc.). In an example, the logistics 110 can handle shipping and inventory needs for the platform 102. In another example, the logistics 110 can handle customer support for the platform 102.

In an embodiment, personalized sites that are created by influencers 104 can be accessed by users 104. In one example, the users 104 can be tribe members who have joined the tribes created by the influencers 106. After joining the platform 102 as tribe members, such users can have access to the personalized sites hosted on the platform 102. In another example, the users 104 can be third-party users who wish to access the marketplace in order to purchase items or services provided by the influencer 106 as a gift.

In an embodiment, the platform 102 can be accessed by businesses 108 that have endorsement deals with the influencers 106 and/or businesses that are seeking to establish a business relationship with the influencers 106. When accessing the platform 102, the businesses 108 can have access to sales data of the products and services that are sold via the personalized sites of influencers 106. The sales data can be indicative of quantities of specific products and services that are sold, date of sales, revenue, profit margins, among other sales data. The sales data can be filtered and viewed based on country, date of sale, product type, profit margin, etc. Providing access to such sales data can provide the businesses 108 with insights on the influencer 106's influence in a particular country or region. It could also provide the businesses 108 with insights on the influencer 106's ability to market and sell a particular type of product. As explained herein, such sales data is valuable to the businesses 108 when evaluating influencers 106 for endorsement contracts.

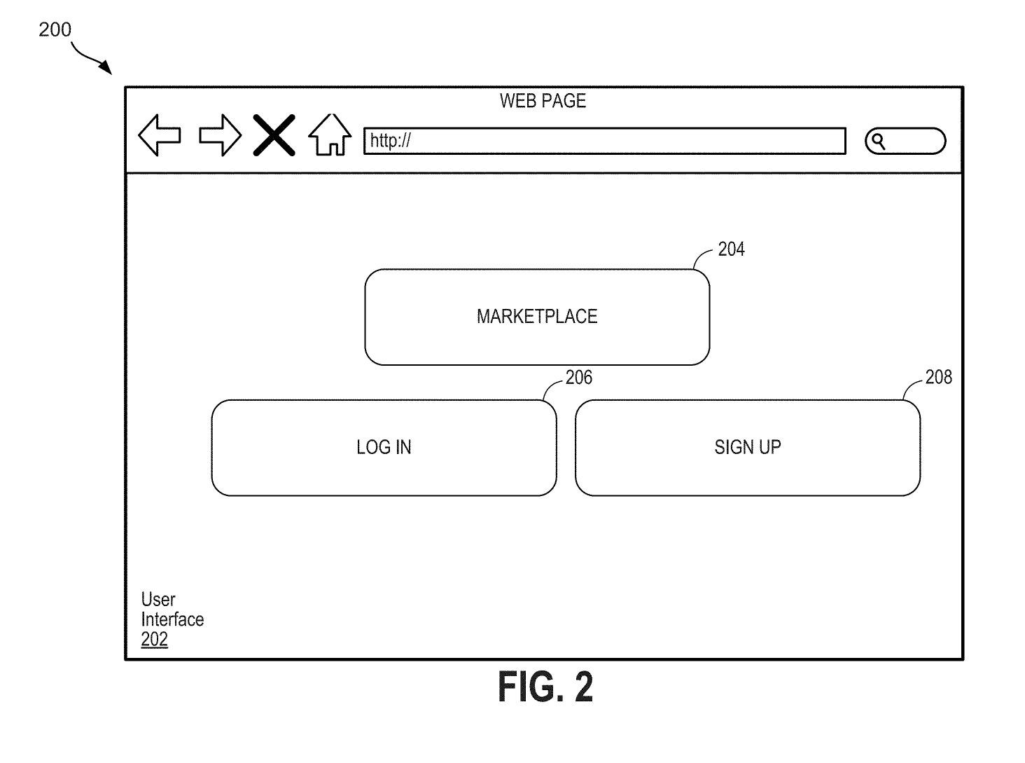

FIG. 2 illustrates a web page 200 accessing a homepage of the online platform for influencers, according to an example embodiment. As illustrated in FIG. 2, the web page includes a user interface 202. As shown in the user interface 202, the homepage can include one or more selectable icons 204, 206, and 208. Thus, a user browsing the homepage can select one of the icons 204, 206, and 208. In particular, the user can select the icon 204 “MARKETPLACE” to enter a marketplace hosted on the online platform. As described herein, the marketplace can include items and services sold by influencers on their personalized sites. As also described herein, the user can use the marketplace to generate a gift recommendation and purchase a gift for a gift recipient (e.g., a tribe member). Alternatively, the user can select the icon 206 “LOG IN” in order to provide login information to log in into an influencer account, a tribe member account, or a business account. Based on the login information provided, the web page can then direct the user to the appropriate web page (e.g., an influencer interface, a business interface, or a tribe member interface).

Alternatively, if the user does not have an account with the platform, the user can select the icon 208 “SIGN UP” to join the platform. Once the user selects the icon 208, the web page directs the user to a new web page where the user could sign up to join the platform. Within examples, the user can open an influencer account, a tribe member account, and/or a business account. Note that the layout of the web page 200 is merely for illustration purposes and should not be construed as limiting. Other example web page layouts and designs are possible.

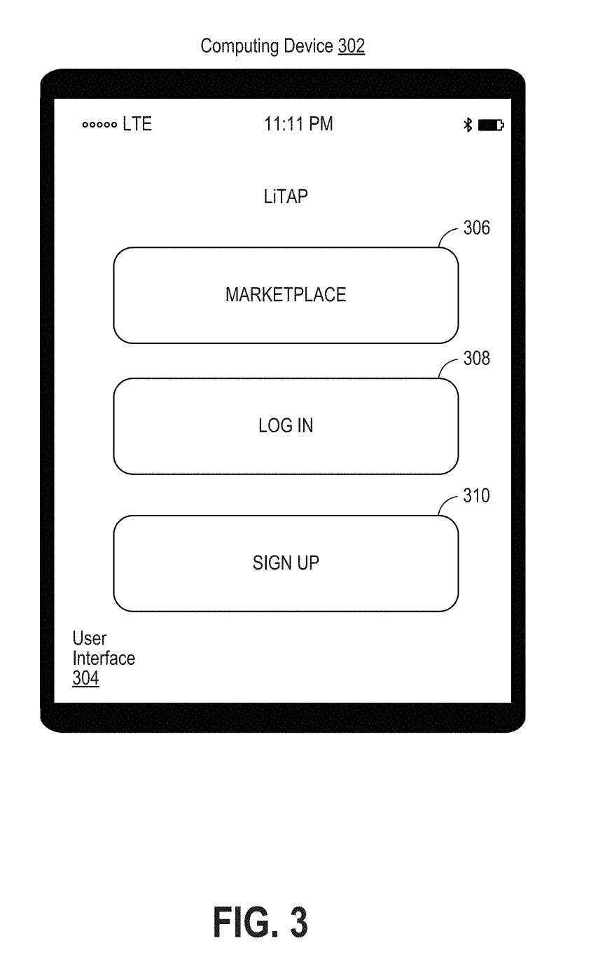

FIG. 3 illustrates a computing device 302 accessing the portal via a computing device application, according to an example embodiment. Within examples, the computing device 302 can be a desktop computer, a laptop computer, a mobile device, a head-mountable device (HMD), among other examples.

As illustrated in FIG. 3, the computing device application includes a user interface 304. Similar to the user interface 202 in FIG. 2, the user interface 304 includes three selectable icons 306, 308, and 310. Similar to the functionality of the icons in FIG. 2, the user can select one of the icons 306, 308, 310 in order to access the marketplace hosted on the platform, log in into a user account, or sign up for an account. Note that the user interface 304 of the computing device application is merely for illustration purposes and should not be construed as limiting. Other example user interfaces of computing device applications are also possible.

### III. Example Graphical User Interface (GUI) of the Online Platform for Influencers

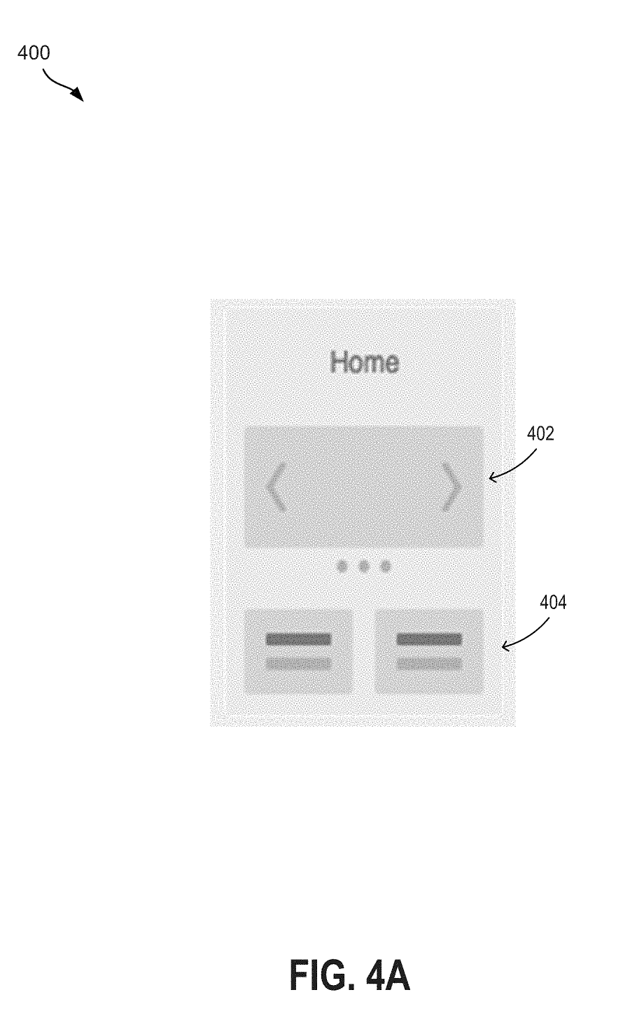

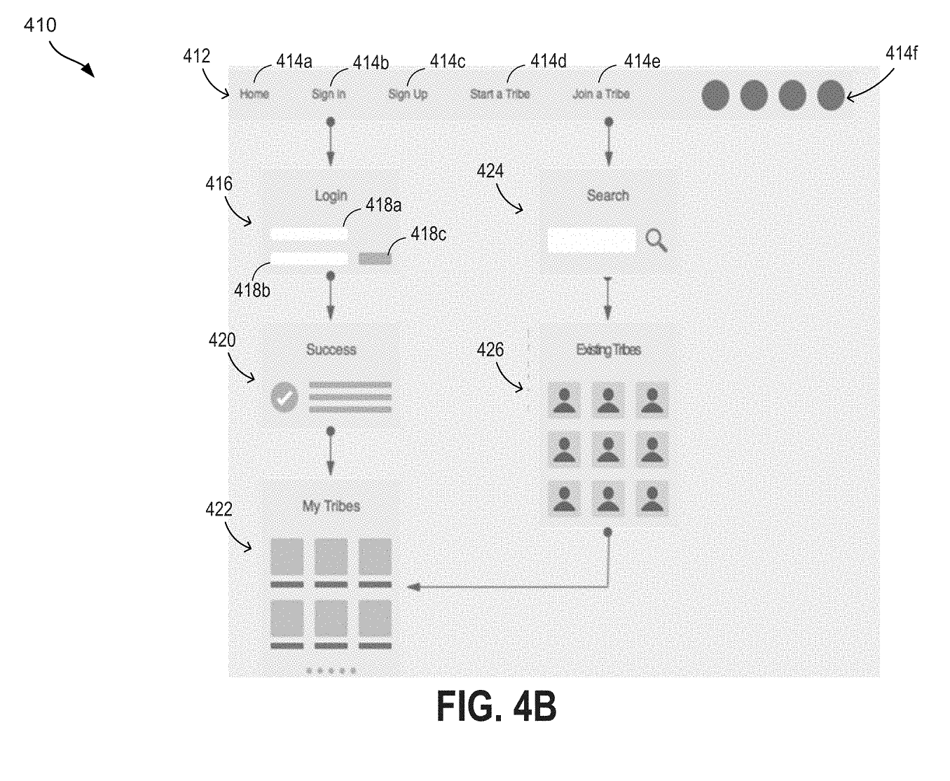

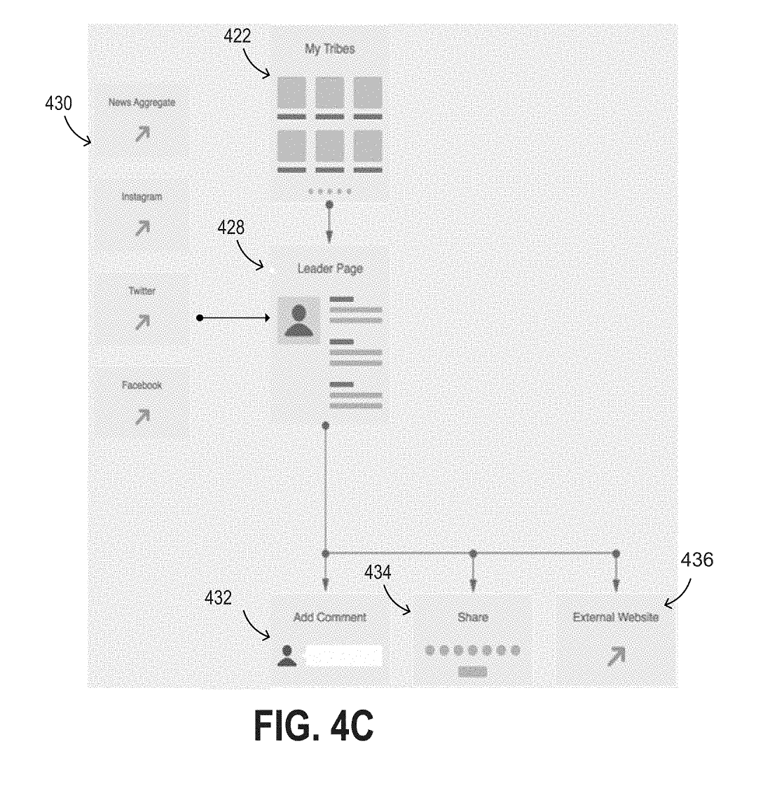

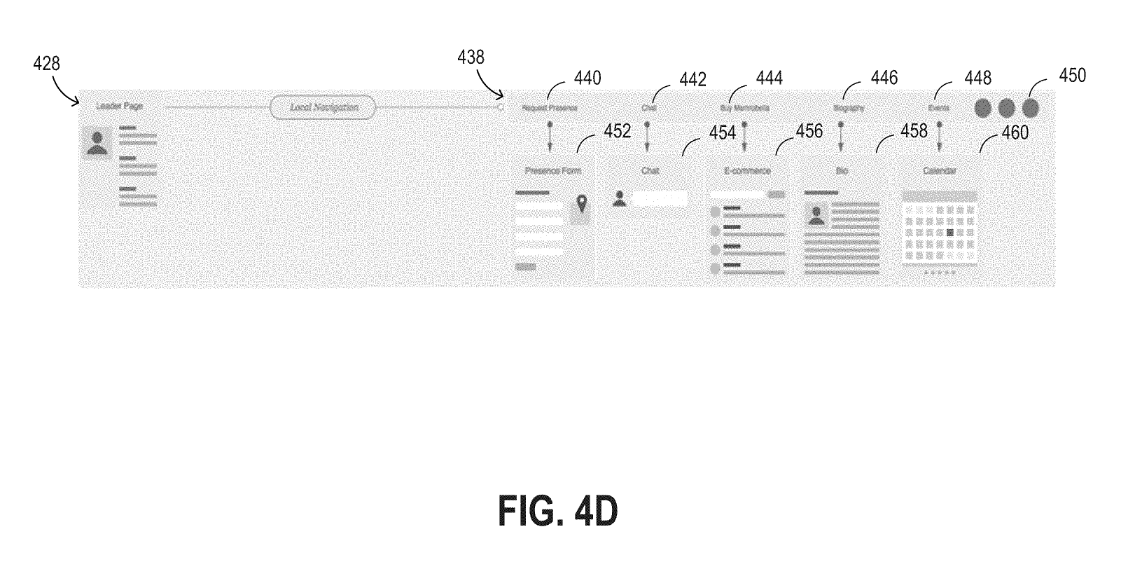

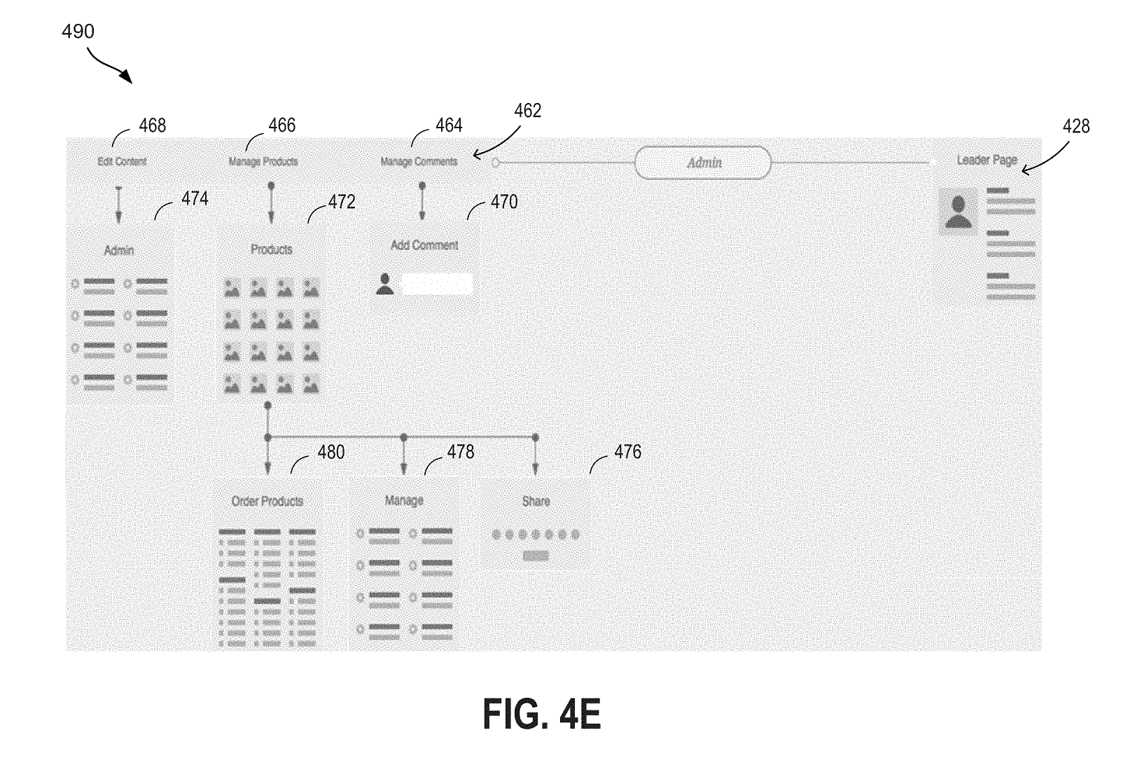

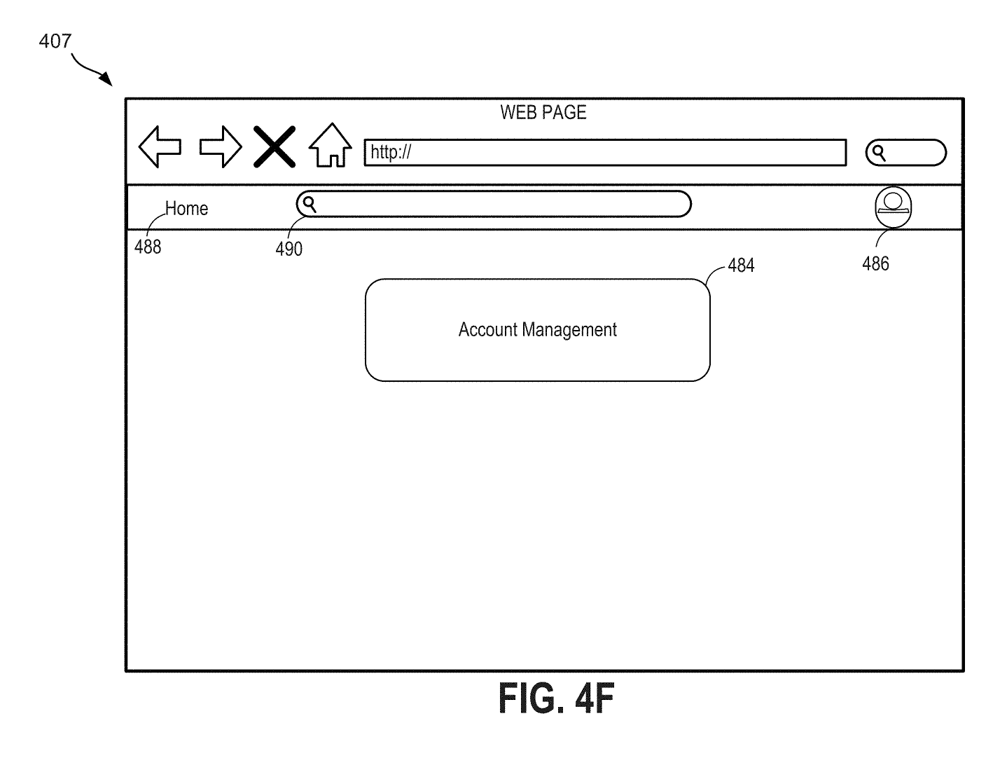

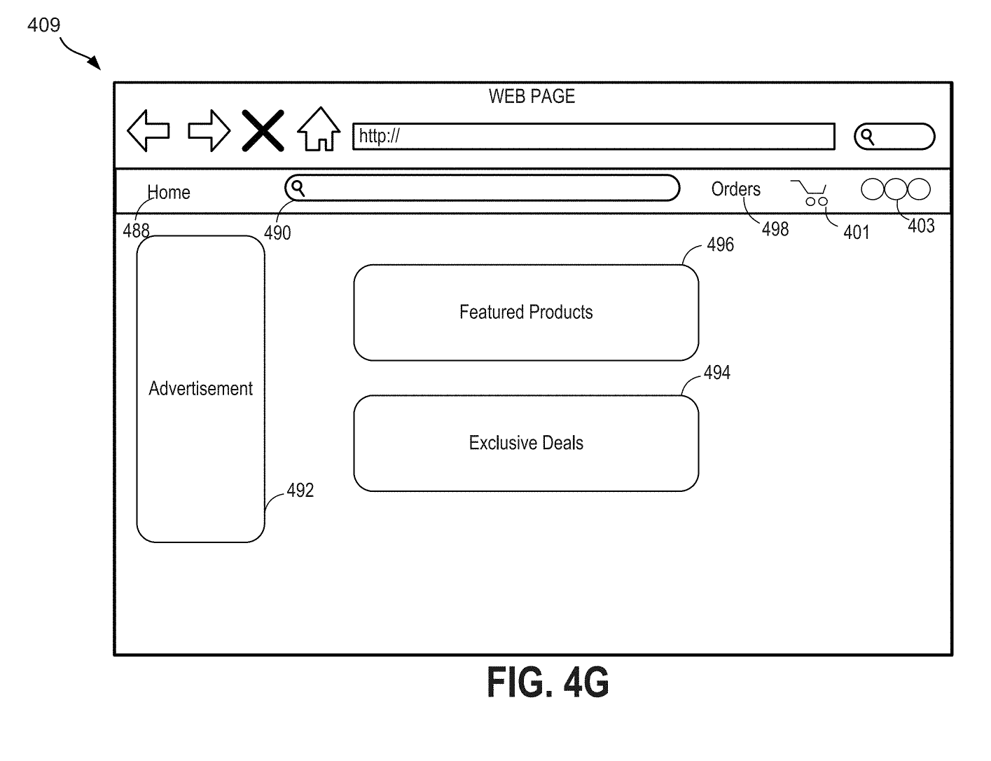

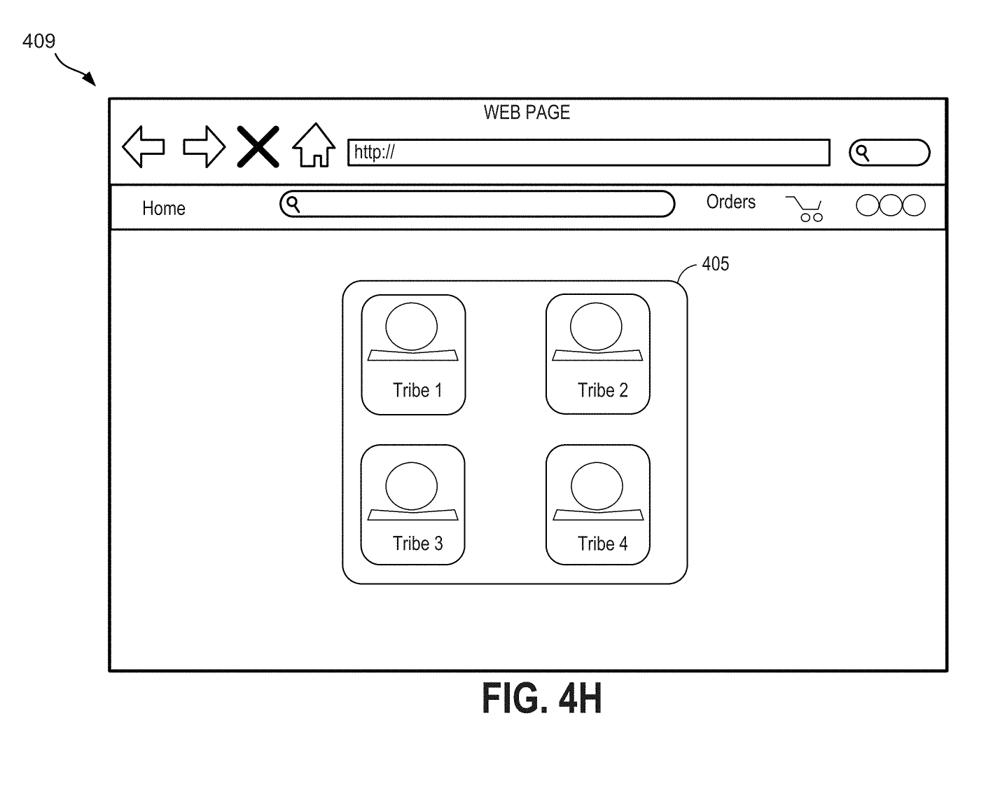

FIG. 4A illustrates a home page 400 of the online platform for influencers, according to an example embodiment. Within examples, the home page 400 can be accessed via a web page or a computing device application, perhaps the web page 200 in FIG. 2 or the computing device application in FIG. 3. Section 402 of the home page 400 provides an overview of the platform. This section 402 could describe the various sections of the platform and the structure of the platform. It could also describe various subscription plans, information on how to join the platform, among other information. As illustrated in FIG. 4A, the home page 400 also includes section 404 that includes one or more promotional blocks. In the example illustrated in FIG. 4A, the section 404 includes two promotional blocks. These promotional blocks could provide an overview of the key features of the product, what users can expect and achieve by using the platform (e.g., the benefit that influencers, tribe members, and businesses could achieve by using the platform).

FIG. 4B illustrates the main navigation GUI 410 for the online platform, according to an example embodiment. As illustrated in FIG. 4B, the main navigation GUI 410 includes a navigation taskbar 412 that includes clickable icons 414a, 414b, 414c, 414d, 414e, and clickable buttons 414f. The icon 414a takes the user to a home page of the platform. The icon 414b opens a log in page or window 416. As illustrated in FIG. 4B, the log in window 416 includes a username field 418a, a password field 418b, and clickable icon 418c. Once the user enters the username into the field 418a and the password into the field 418b, the user can log in by clicking the icon 418c. If the log in information is correct (i.e., the log in information is associated with a user account), then a success window 420 opens. The success window then directs the user to a home page 422 for the user. As illustrated in FIG. 4B, the home page 422 can include a list of the tribes that the tribe member has joined.

The navigation taskbar 412 also includes the icon 414b “Sign Up.” Clicking this icon directs the user to a sign up page (not illustrated) to join the platform. As explained herein, the user can join the platform by opening an influencer account, a tribe member account, or a business account.

The navigation taskbar 412 also includes the icon 414d “Start a Tribe” that directs an influencer to an interface that can be used to create and/or manage a tribe. Note that the icon 414d becomes functional only after the tribe member has signed into the platform using an influencer account. The navigation taskbar 412 also includes the icon 414e “Join a Tribe” that opens a search window 424 that allows the user to search for tribes that are available on the platform, perhaps by searching for a name of an influencer. Once the user performs the search, the user could be directed to a search results page 426. The user could add one or more of the tribes listed in the search results to their list of tribes, which are listed on the user's home page 422. Note that the icon 414e becomes functional only after a tribe member has signed into the platform using a tribe member account. Also note that search queries other than influencer names are also possible.

The navigation taskbar 412 also includes the clickable buttons 414f. These buttons 414f could function as shortcuts to social media sites of the platform. Examples of social media sites include Facebook®, Twitter®, Instagram®, among other examples.

As illustrated in FIG. 4C, a tribe member can select one of the tribes listed on the “My Tribes” page 422. Selecting one of the tribes can direct the tribe member to a leader page 428. The leader page 428 is the personalized page of the influencer of the tribe. The leader page 428 can include information about the influencer. As illustrated in FIG. 4C, the leader page 428 can also include news and social feeds 430 that could be posted on the leader page 428. As also illustrated in FIG. 4C, the leader page 428 could also include a comment window 432, a share button 434, and links to external websites 436.

As illustrated in FIG. 4D, the leader page 428 also includes a taskbar 438 that includes clickable buttons 440, 442, 444, 446, 448, and 450. The button 440 “Request Presence” could direct the user to a presence request form page 452. As illustrated in FIG. 4D, the page 452 could include Tillable fields that could include fields where the tribe member could provide details such as: (i) the event where the presence of the influencer is requested, (ii) the date of the event, (iii) the location of the event, (iv) the length of time that the presence of the influencer is requested, among other information.

The button 442 “Chat” could direct the user to a chat window 454. The chat window 454 could be used to exchange private messages between the tribe member and the influencer. The button 444 “Buy Memorabilia” could direct the tribe member to an “E-commerce” window 456. In an embodiment, the E-commerce window 456 could include a listing of all of the items and services that are sold by the influencer. As explained herein, the items could include items that are endorsed by the influencer and items that are personalized by the influencer. Further, on this page 456, the tribe member could request the influencer to personalize a specific item. In particular, the item could be personalized to include a desired message for a particular individual.

The button 446 “Biography” could direct the tribe member to a “Bio” page 458 that includes a biography of the influencer that has been approved by the influencer. The button 448 could direct the tribe member to a “Calendar” page 460. The calendar page 460 can include a calendar that lists any public appearances by the influencer. The calendar could also include dates of events associated with the influencer, such as concert dates, album release dates, movie release dates, etc. The buttons 450 could link to various social media pages associated with the influencer.

FIG. 4E illustrates an influencer interface 490 that can be used by an influencer to manage the influencer's personalized site or tribe. The interface 490 could be accessed by an administrator of the personalized site or the tribe. As illustrated in FIG. 4E, the interfaced 490 could include a taskbar 462 that includes clickable buttons 464, 466, and 468. In an embodiment, the button 464 “Manage Comments” allows the influencer to add comments to a comment page 470. On the comment page 470 the influencer could also delete or modify comments that have been submitted by tribe members via the tribe member interface.

The button 466 “Manage Products” directs the influencer to a “Products” page 472. On this page, the influencer could access an “Order Products” page 480 in order to order to replenish stocks of items that are sold in the marketplace. The influencer could also access a “Manage” page that allows the influencer manage the products and services that are provided by the influencer. On this page, the influencer could edit pricing of the items and services provided in the influencer's marketplace. The influencer could also add or remove the items and services that are offered on the marketplace. In some examples, the influencer could also assign an exclusivity level to certain items and services. For instance, certain items and services can be offered exclusively for tribe members of the influencer's tribe. From the page 472, the influencer could also access a “Share” page 476. On this page, the influencer could share items or services that are sold in the marketplace to external websites, such as social media websites.

The button 468 “Edit Content” directs the influencer to an “Admin” page 474. On this page, the influencer can tweak or adjust any aspect of the influencer's personalized site. This includes managing the various pages of the personalized site, content shared on the pages, comments made on the pages, etc.

FIG. 4F illustrates another influencer interface 407 that can be used by an influencer to manage the influencer's personalized site or tribe. As illustrated in FIG. 4F, the interface 407 can include an “Account Management” interface 484, perhaps the interface described in FIG. 4F. Additionally, the interface 407 can include a “Home” button 488 and a search bar “490.” The interface 407 can also include a user icon 486. Among other functionalities, clicking on the user icon 486 can allow an influencer to easily switch between their influencer management account and a personal account that they could use to follow other influencers and/or to purchase items from the platform.

FIG. 4G illustrates a guest user interface 409 that can be accessed by a guest user visiting the online page of the platform, according to an example embodiment. As explained above, the marketplace can be accessed by guest users who do not have an account with the platform. When such guest users access the platform, the interface 409 can be displayed. As illustrated in FIG. 4G, the interface 409 can include a “Home” button 488, a search bar 490, an “Orders” button 498, a shopping cart button 401, and social media buttons 403. Additionally, a home page of the interface 409 can display featured products 496, exclusive deals 494, and advertisements 492. Within examples, a guest user can use the search bar 490 to search for a particular tribe, an influencer, a tribe member, or a product. For instance, the guest user can search for an influencer. Note that a guest user can also access a guest user interface in a mobile device application as well.

FIG. 4H illustrates the results of a guest user searching for an influencer, according to an example embodiment. As illustrated in FIG. 4H, the interface 409 can display search results for a search query for an influencer. As illustrated in FIG. 4H, the search results could include one or more tribes that are associated with the user's search query. The user can then select the tribe that they wish to view.

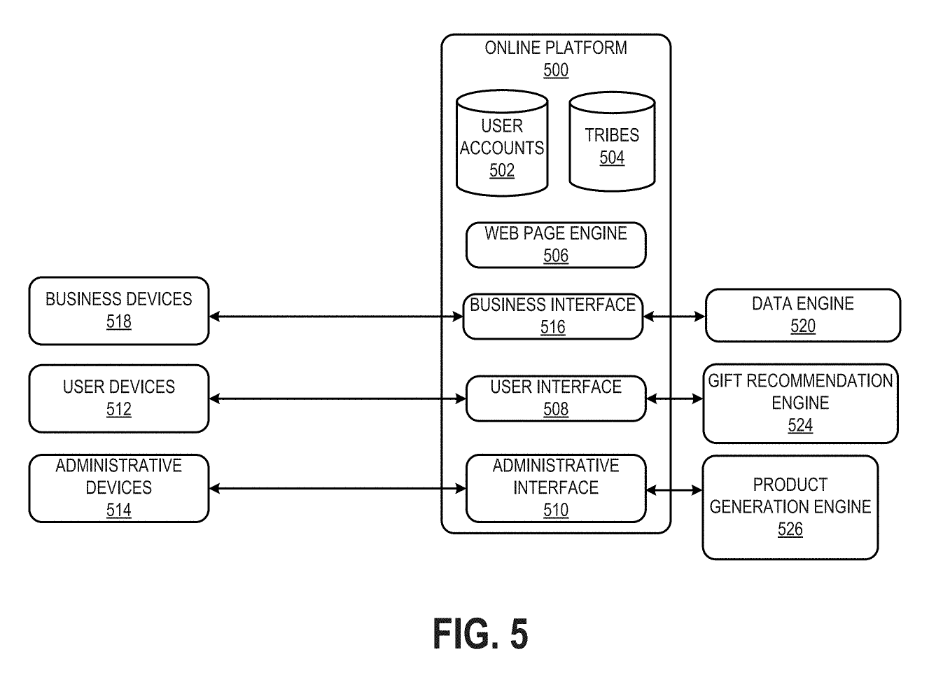

FIG. 5 is a depiction of an online platform 500, as well as its connectivity to other entities. The online platform 500 may be software that operates on one or more computing devices, such as server devices. In some examples, the online platform 500 can be implemented as a “cloud-based” service on Internet servers, accessible via computing device applications, for instance. Alternatively or additionally, the online platform 500 may consist of client and/or server components.

As depicted in FIG. 5, the online platform 500 can include or have access to user accounts 502, tribes 504, web page engine 506, user interface 508, administrative interface 510, business interface 516, data engine 520, gift recommendation engine 524, and product generation engine 526. In some embodiments, the online platform 500 may include or have access to more or fewer elements, or these elements may be arranged differently.

User accounts 502 can be a database and/or some other organization of information that represents attributes of one or more users of the online platform 500, such as influencers, tribe members, and businesses. Thus, for each user, user accounts 502 can include a username, email address, physical address, phone number, and/or billing information. User accounts 502 can also include representations of a type of account for the user, such as influencer account, a tribe member account, and a business account. User accounts 502 may additionally include representations of options and/or configuration data associated with the user. At least some of these options and/or configuration data may be set, updated, or modified by the user.

Tribes 504 can be a database and/or some other organization of information that represents attributes of one or more tribes of the online platform 500. The tribes 504 can include information about the tribes and the associated personalized sites including the items and services that are sold in the marketplace of each tribe. The tribes 504 can also include information about the user accounts 502 that are associated with each tribe of the tribes 504.

Web page engine 506 may be software arranged to render information included in tribes 504 into a web page for viewing by a user, administrator, or business. For instance, web page engine 506 may be able to receive a request for information from one of user devices 512, retrieve the associated content from tribes 504, format the retrieved content in accordance with the user account of the user, and provide a representation of this data to the user device via user interface 508. The representation may take the form of one or more documents and related information that can be rendered, as a web page, on a user interface of the user device. Web page engine 506 may be able to perform other functions as well.

User interface 508 may be a representation of what a user sees when he or she accesses information via the online platform 500. For instance, user interface 508 may take the form of one or more columns of information that was formatted by web page engine 506. Within examples, the user interface may be similar to or identical to the graphical user interfaces described in FIGS. 2, 3, and 4A-4E. User interface 508 may also support a mode in which a user can view and/or edit his or her user account information and settings.

In embodiment, the user interface 508 can display an entry field for a gift recommendation request. In particular, an individual seeking to purchase a gift for a gift recipient can use the entry field to request a gift recommendation for the gift recipient. In an example, the individual can include information that identifies the gift recipient such as name, age, gender, interests, social media profile, etc. After filling out the appropriate entry fields, the individual can then submit the gift recommendation request.

In response to receiving the gift recommendation request via the user interface 508, the online platform 500 can use a gift recommendation engine 524 to generate the gift recommendation for the gift recipient. In an embodiment, the gift recommendation engine 524 can use the information submitted to the online platform 500 in order to generate the gift recommendation. For instance, the gift recommendation can be based on an age and gender of the gift recipient. In another example, the gift recommendation engine can retrieve information indicative of the gift recipient's interests from social media profiles of the gift recipient. Then the gift recommendation engine can generate the gift recommendation based on the information retrieved from the gift recipient's social media profiles.

In an embodiment, the gift recommendation engine 524 can search the user accounts 502 to determine whether the gift recipient is a tribe member of one or more tribes 504. If the gift recipient is a tribe member, then the gift recommendation engine 524 can use information from the tribes in order to generate a gift recommendation for the gift recipient. For instance, the gift recommendation engine 524 can determine a gift recommendation for the gift recipient based on a tribe that the gift recipient has joined.

In an embodiment, the gift recommendation can be a product or service sold in the marketplace of one of the tribes that the gift recipient has joined. For instance, the gift recommendation engine 524 can determine, based on data from tribes 504, that the gift recipient is an active member of a particular tribe. Accordingly, the gift recommendation engine 524 can determine that the gift recipient would value a gift associated with the influencer of the particular tribe. In response to making this determination, the gift recommendation engine can select a product or service that is provided by the influencer as the gift recommendation.

Once the gift recommendation engine 524 has generated the gift recommendation, the user interface 508 can display the gift recommendation. In some examples, the gift recommendation engine 524 can generate more than one gift recommendation. The more than one gift recommendation can then be displayed on the user interface 508. The individual seeking the gift recommendation can then filter the more than one gift recommendation based on price, availability, delivery time, etc., in order to choose between the different gift recommendations. Once the individual has selected the gift, the individual can place an order for the gift through the user interface 508.

Administrative interface 510 may be a representation of what an administrator (e.g., an influencer) sees when he or she accesses the online platform 500. Thus, administrative interface 510 may allow an administrator to upload, write, and/or edit articles or other content. In addition to the details of the administrative interface described above, the administrative interface 510 may present information regarding the configuration, status, and/or health of the online portal 500.

In an example embodiment, the administrative interface 510 can display products that have been generated by a product generation engine 526. In particular, the product generation engine 526 can generate one or more product suggestions to be sold in a marketplace of a tribe. For instance, the product generation engine can autonomously generate one or more suggested products, which can then be displayed on the administrative interface 510 for approval by the influencer.

In an embodiment, the product generation engine 526 can generate product recommendations based on news stories, product sales data, and/or social media posts. For example, the product generation engine can detect social media posts that are quoting a particular quote made by an influencer. By way of example, the quote could have been a quote made by the influencer during an interview or a line of song that went viral. In response, the product generation engine can generate one or more products that include the particular quote by the influencer. For instance, the product generation engine 524 can generate a t-shirt emblazoned with the viral quote.

Business interface 516 may be a representation of what a business sees when accessing information via the online platform 500. For instance, business interface 516 may take the form of one or more columns of sales data that was formatted by web page engine 506. In an embodiment, the business interface 516 can display data that has been generated by the data engine 520. In particular, the sales data can be indicative of quantities of specific products and services that are sold, date of sales, revenue, profit margins, among other sales data. This sales data can be accessed by a business device 518 that is operated by a business that has an endorsement contract with an influencer or that is seeking to establish an endorsement contract with an influencer.

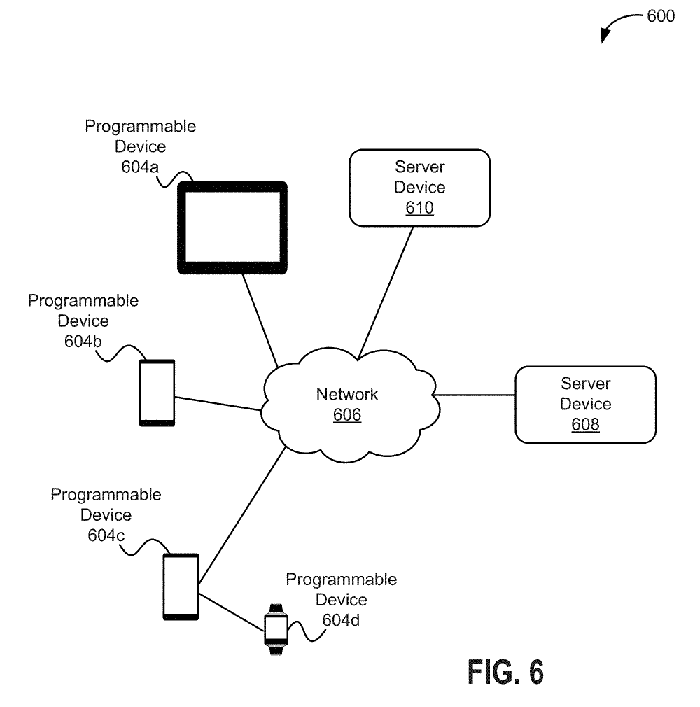

Accordingly, the online platform 500 may facilitate online access from one or more user devices 512, administrative devices 514, and/or business devices 518. Each of user devices 512, administrative devices 514, and/or business devices 518 may be a computing device (e.g., the programmable devices described in FIG. 6), and these computing devices may be interconnected to the online platform 500 by a computer network, such as the Internet or one or more private networks.

Note that the online platform 500, user devices 512, administrative devices 514, and/or business devices 518, as well as any other device or function associated with the architecture of FIG. 5, can represent, be operated on, or be operated by one or more computing devices. These computing devices may be organized in a standalone fashion, in networked computing environments, or in other arrangements.

FIG. 6 depicts a distributed computing architecture 600 with server devices 608, 610 configured to communicate, via network 606, with programmable devices 604a, 604b, 604c, 604d, in accordance with at least some example embodiments. Network 606 may correspond to a LAN, a wide area network (WAN), a corporate intranet, the public Internet, or any other type of network configured to provide a communications path between networked computing devices. Network 606 may also correspond to a combination of one or more LANs, WANs, corporate intranets, and/or the public Internet.

Although FIG. 6 shows four programmable devices, distributed computing architecture 600 can serve more, fewer, and/or different programmable devices. Moreover, programmable devices 604a, 604b, 604c, 604d (or any additional programmable devices) may be any sort of computing device, such as an ordinary laptop computer, desktop computer, wearable computing device, mobile computing device, head-mountable device (HMD), network terminal, wireless communication device (e.g., a smart phone or cell phone), and so on. In some embodiments, such as indicated with programmable devices 604a, 604b, 604c, programmable devices can be directly connected to network 606. In other embodiments, such as indicated with programmable device 604d, one or more programmable devices can be indirectly connected to network 606 via an associated computing device, such as programmable device 604c. In this example, programmable device 604c can act as an associated computing device to pass electronic communications between programmable device 604d and network 606. In still other embodiments not shown in FIG. 6, a programmable device can be both directly and indirectly connected to network 606.

Server devices 608, 610 can be configured to perform one or more services, as requested by programmable devices 604a-604d. For example, server device 608 and/or 610 can provide content to programmable devices 604a-604d. The content can include, but is not limited to, web pages, hypertext, scripts, binary data such as compiled software, images, audio, and/or video. The content can include compressed and/or uncompressed content. The content can be encrypted and/or unencrypted. As another example, server device 608 and/or 610 can provide programmable devices 604a-604d with access to software for database, search, computation, graphical, audio, video, World Wide Web/Internet utilization, and/or other functions. Many other examples of server devices are possible as well.

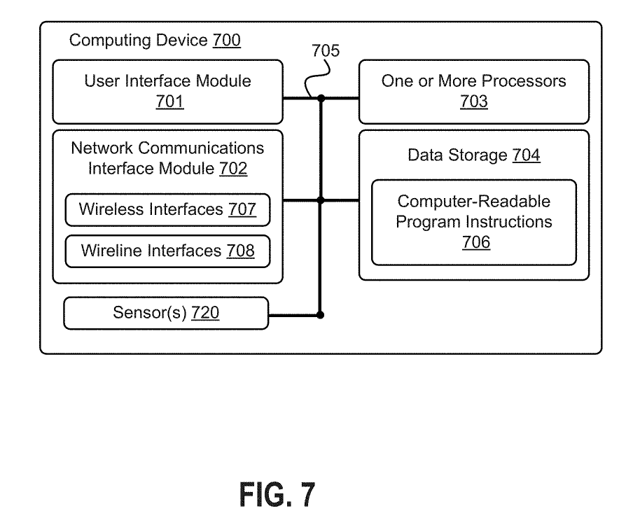

FIG. 7 is a functional block diagram of computing device 700, in accordance with at least some example embodiments. In particular, computing device 700 shown in FIG. 7 can be configured to perform at least one function related to the gift recommendation algorithm, the data engine, the product generation engine, business devices, user devices, and/or administrative devices.

Computing device 700 may include a user interface module 701, a network-communication interface module 702, one or more processors 703, data storage 704, and one or more sensors 720, all of which may be linked together via a system bus, network, or other connection mechanism 705.

User interface module 701 can be operable to send data to and/or receive data from external user input/output devices. For example, user interface module 701 can be configured to send and/or receive data to and/or from user input devices such as a keyboard, a keypad, a touch screen, a computer mouse, a track ball, a joystick, a camera, a voice recognition module, and/or other similar devices. User interface module 701 can also be configured to provide output to user display devices, such as one or more cathode ray tubes (CRT), liquid crystal displays, light emitting diodes (LEDs), displays using digital light processing (DLP) technology, printers, light bulbs, and/or other similar devices, either now known or later developed. User interface module 701 can also be configured to generate audible output(s), such as a speaker, speaker jack, audio output port, audio output device, earphones, and/or other similar devices. User interface module 701 can further be configured with one or more haptic devices that can generate haptic output(s), such as vibrations and/or other outputs detectable by touch and/or physical contact with computing device 700. In some embodiments, user interface module 701 can be used to provide a graphical user interface (GUI) for utilizing computing device 700.

Network-communications interface module 702 can include one or more wireless interfaces 707 and/or one or more wireline interfaces 708 that are configurable to communicate via a network. Wireless interfaces 707 can include one or more wireless transmitters, receivers, and/or transceivers, such as a Bluetooth™ transceiver, a Zigbee® transceiver, a Wi-Fi™ transceiver, a WiMAX™ transceiver, a 2G transceiver, a 3G transceiver, a 4G transceiver, a 5G transceiver, and/or other similar type of wireless transceiver configurable to communicate via a wireless network. Wireline interfaces 708 can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some embodiments, network communications interface module 702 can be configured to provide reliable, secured, and/or authenticated communications. For each communication described herein, information for ensuring reliable communications (i.e., guaranteed message delivery) can be provided, perhaps as part of a message header and/or footer (e.g., packet/message sequencing information, encapsulation header(s) and/or footer(s), size/time information, and transmission verification information such as CRC and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), an Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA).

Other cryptographic protocols and/or algorithms can be used as well or in addition to those listed herein to secure (and then decrypt/decode) communications.

One or more processors 703 can include one or more general purpose processors, and/or one or more special purpose processors (e.g., digital signal processors, graphics processing units, application specific integrated circuits, etc.). One or more processors 703 can be configured to execute computer-readable program instructions 706 that are contained in data storage 704 and/or other instructions as described herein.

Data storage 704 can include one or more computer-readable storage media that can be read and/or accessed by at least one of one or more processors 703. The one or more computer-readable storage media can include volatile and/or non-volatile storage components, such as optical, magnetic, organic or other memory or disc storage, which can be integrated in whole or in part with at least one of one or more processors 703. In some embodiments, data storage 704 can be implemented using a single physical device (e.g., one optical, magnetic, organic or other memory or disc storage unit), while in other embodiments, data storage 704 can be implemented using two or more physical devices.

Data storage 704 can include computer-readable program instructions 706 and perhaps additional data. In some embodiments, data storage 704 can additionally include storage required to perform at least part of the herein-described methods, scenarios, and techniques and/or at least part of the functionality of the herein-described devices and networks. For example, computer-readable program instructions 706 can, when executed by one or more processors 703, cause computing device 700 to perform at least one function related to one or more of: the gift recommendation algorithm, the data engine, the product generation engine, business devices, user devices, and/or administrative devices.

In some embodiments, computing device 700 can include one or more sensors 720. Sensor(s) 720 can be configured to measure conditions in an environment of computing device 700 and provide data about that environment. For example, sensor(s) 720 can include one or more of: (i) an identification sensor to identify other objects and/or devices, such as, but not limited to, a Radio Frequency Identification (RFID) reader, proximity sensor, one-dimensional barcode reader, two-dimensional barcode (e.g., Quick Response (QR) code) reader, and a laser tracker, where the identification sensor(s) can be configured to read identifiers, such as RFID tags, barcodes, QR codes, and/or other devices and/or object configured to be read and provide at least identifying information; (ii) sensors to measure locations and/or movements of computing device 700, such as, but not limited to, a tilt sensor, a gyroscope, an accelerometer, a Doppler sensor, a Global Positioning System (GPS) device, a sonar sensor, a radar device, a laser-displacement sensor, and a compass; and (iii) an environmental sensor to obtain data indicative of an environment of computing device 700, such as, but not limited to, an infrared sensor, an optical sensor, a light sensor, a camera, a biosensor, a capacitive sensor, a touch sensor, a temperature sensor, a wireless sensor, a radio sensor, a movement sensor, a microphone, a sound sensor, an ultrasound sensor, and/or a smoke sensor; Many other examples of sensor(s) 720 are possible as well.

### IV. Example of Using the Platform

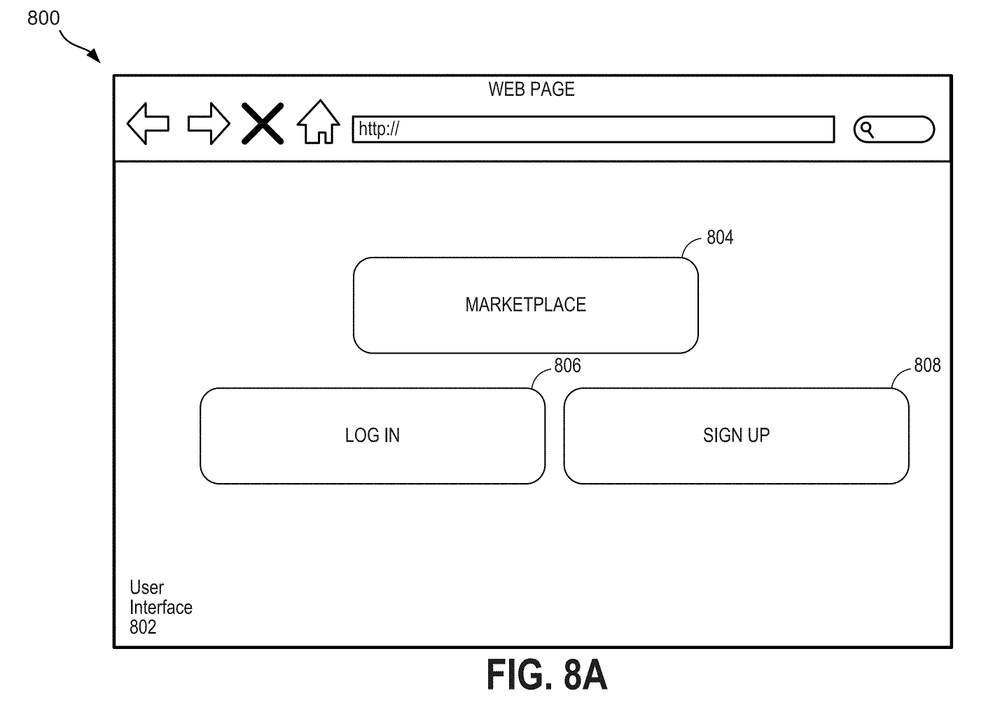

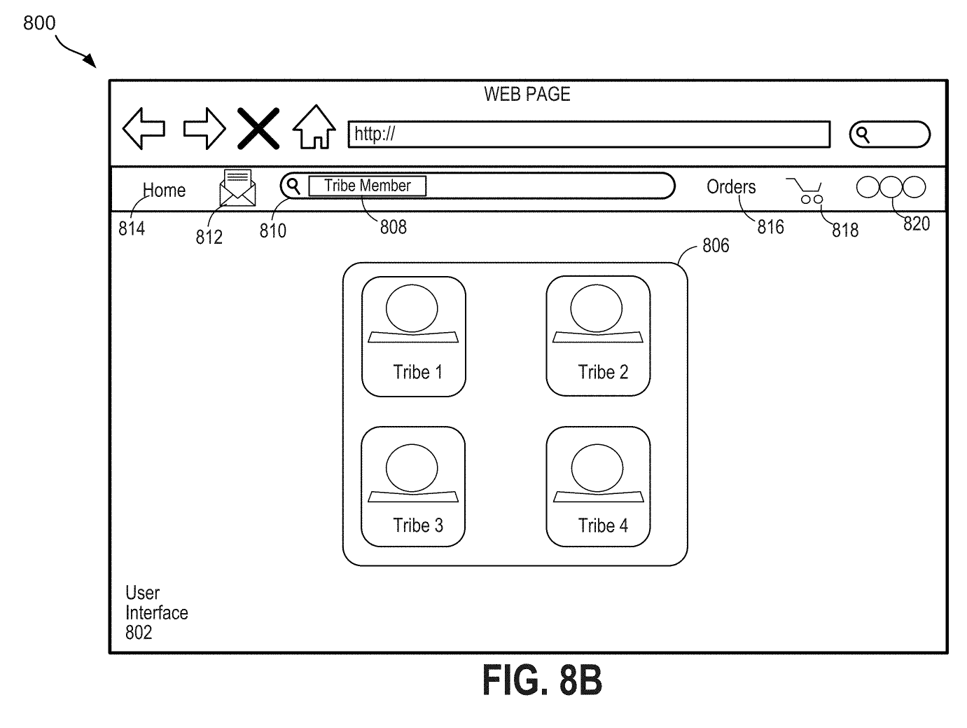

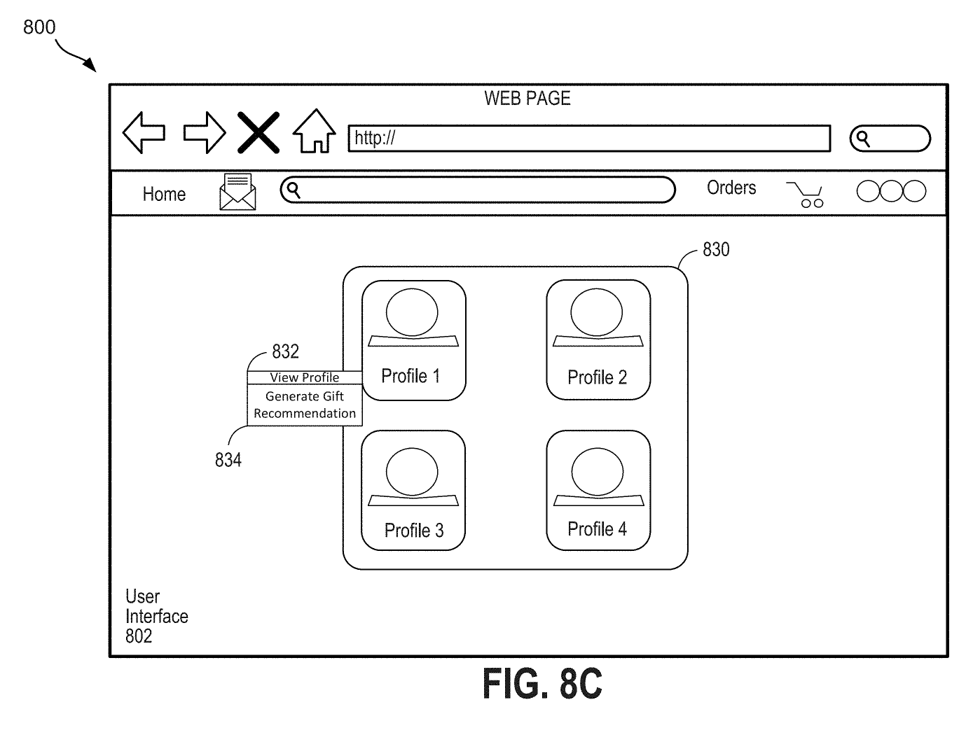

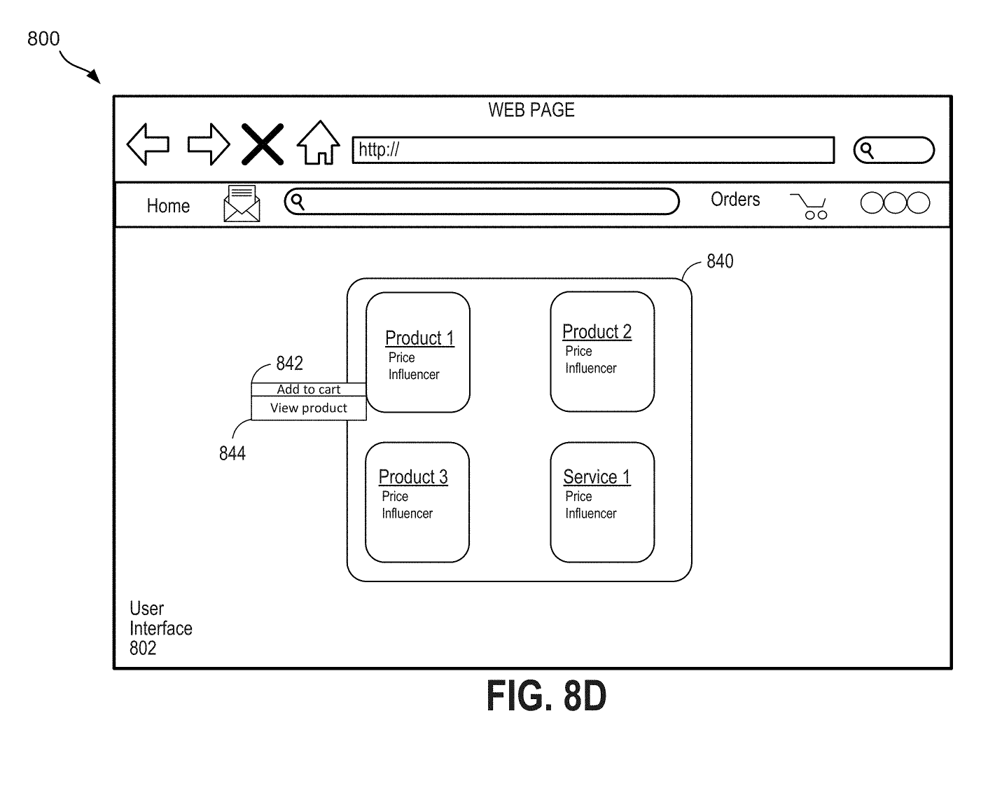

FIGS. 8A, 8B, 8C, and 8D illustrate an example 800 of using the online platform, according to an example embodiment. As illustrated in FIG. 8A, a user interface 802 can display a homepage of the platform. The user interface 802 also displays a marketplace button 804, a log in button 806, and a sign up button 808. Within examples, if the user is a guest and would like to directly access the marketplace without logging in, the user can select the marketplace button 804. Alternatively, the user can log in by selecting the log in button 806. Alternatively, the user can sign up to join the platform by clicking the sign up button 808. In this example, the user is already a subscribed user, and thus, the user logs in by selecting the log in button 806.

Once the user logs in, the user interface 802 can display a custom homepage for the user. For instance, as illustrated in FIG. 8B, the user interface can display a window 806 that lists the tribes that are followed by the user. As also illustrated in FIG. 8B, the user interface 802 can also include a home button 814, a messages button 812, a search bar 810, an orders button 816, a shopping cart button 818, and social media buttons 820. The home button 814 can direct a user to the homepage of the marketplace. The messages button 812 can direct the user to a messaging interface. The search bar 810 can allow the user to search the marketplace for a tribe, an influencer, a tribe member, and/or a product. As illustrated in FIG. 8B, the search bar 810 can include a drop-down menu 808 that allows the user to specify the category of what the user is searching for when using the search bar (e.g., a tribe, an influencer, a tribe member, and/or a product). In this example, the user is searching for a tribe member that they would like to purchase a gift for. As such, the user selects “Tribe Member” from the drop-down menu 808, and enters a search query into the search bar 810.

As illustrated in FIG. 8C, the user interface can display the search results in a window 830. The results can include several user profiles that correspond to the search query. Within examples, the user can select the profile for which they were searching. Selecting the profile can cause the user interface 802 to display a menu that includes several buttons. As illustrated in FIG. 8C, the buttons can include a button 832 that allows the user to view the profile, and can include a button 834 that can generate a gift recommendation for the profile. In this example, the user wishes to purchase a gift for a tribe member, thus the user can select the button 834. Selecting the button 834 can cause the gift recommendation engine of the platform to generate one or more gift recommendations for the tribe member.

FIG. 8D illustrates a user interface that displays gift recommendations for a tribe member, according to an example embodiment. As illustrated in FIG. 8D, the user interface can display a window 840 that displays several gift recommendations for the tribe member. For each gift recommendation, the window 840 can also display a price of the item and an influencer from which the gift can be purchased. Selecting a gift profile can cause the user interface 802 to display a menu that includes several buttons. As illustrated in FIG. 8D, the buttons can include a button 842 that allows the user to add the gift to the user's shopping cart, and can include a button 844 that allows the user to view more information about the product (e.g., by directing the user to a webpage dedicated to the gift).

### V. Conclusion

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A system comprising:
at least one processor and executable instructions accessible on a computer-readable medium that, when executed, cause the at least one processor to perform operations comprising:
receiving, via a network, at an online platform hosting a plurality of community pages, an access request from a first user to access the online platform, wherein each community page is associated with a respective influential individual, and wherein each respective community page comprises a listing of items and services provided by the respective influential individual;
in response to providing access to the first user, receiving from the first user, via the network, an information request; and
based on the information request, providing, via the network, corresponding information to the first user.

2. The system of claim 1, wherein the items comprise products personalized by the respective influential individual or products endorsed by the respective influential individual.

3. The system of claim 1, wherein the respective influential individual or a representative of the respective influential individual manages the respective community page.

4. The system of claim 3, wherein the respective influential individual has access to analytical data of the respective influential individual's respective community page, wherein the analytical data comprises data indicative of at least one of: demographics of members of the respective community page, amount of capital spent by the members obtaining items or services from the respective community page, market feedback data on products that the respective influential individual endorses, time spent by members on the respective community page, or amount of capital spent by non-members obtaining items or services from the respective community page.

5. The system of claim 1, wherein the respective community page further comprises a social media feed of the respective influential individual, content aggregated from social media pages associated with the respective influential individual, a messaging interface that allows users to send messages to the respective influential individual, a news feed providing news associated with the respective influential individual, a discussion board moderated by the respective influential individual, a video stream playing video content associated with the respective influential individual, or an archive database of media associated with the respective influential individual, wherein the media comprises photographic, video, or audio media.

6. The system of claim 1, wherein the first user is a member of a first community page, wherein the first user is rewarded for loyalty to the first community page, and wherein the loyalty is measured by a length of time that the first user has been a member of the first community page, a quantity of items that the first user has purchased from the first community page, a total amount of money spent by the first user purchasing items or services from the first community page, or a number of times the first user has participated in the first community page.

7. The system of claim 6, wherein data indicating that the first user is a member of the first community page is confidential.

8. The system of claim 1, wherein the first user is a member of one or more of the plurality of community pages.

9. The system of claim 1, wherein the information request comprises a request for a gift recommendation for a targeted recipient, and wherein the operations further comprise:
based on social media data retrieved from social media pages of the targeted recipient, generating one or more gift recommendations for the targeted recipient.

10. The system of claim 9, wherein generating the one or more gift recommendations for the target recipient comprises:
determining based on the social media data, one or more of the respective influential individuals in which the targeted recipient has an interest; and
selecting one or more personalized items or services from the respective community pages of the one or more respective influential individuals.

11. The system of claim 9, wherein the generating is further based on a geographical location of the targeted recipient, a popularity of the items and services provided by the plurality of community pages, availability of the items and services provided by the plurality of community pages, or a price of the items and services provided by the plurality of community pages.

12. The system of claim 9, wherein the targeted recipient is a member of one or more of the plurality community pages, and wherein the generating one or more gift recommendations for the targeted recipient is further based on at least one of the plurality of community pages of which the targeted recipient is a member.

13. The system of claim 12, wherein the one or more gift recommendations comprise items personalized to the targeted recipient by the one or more respective influential individuals associated with the at least one of the plurality of community pages of which the targeted recipient is a member.

14. The system of claim 1, wherein the information request comprises a request for analytical data associated with a first community page associated with a first influential individual, and wherein the analytical data comprises sales data of the items and services provided on the first community page.

15. The system of claim 14, wherein the analytical data is for a particular item or service.

16. The system of claim 14, wherein the request for analytical data is for analytical data associated with a first geographic area, and wherein the sales data is indicative of sales that occurred in the first geographic area.

17. The system of claim 14, wherein the first user is a company that has an existing endorsement contract with the first influential individual or a company that is seeking to sign an endorsement contract with the first influential individual.

18. A computer-implemented method for generating a gift recommendation, the method comprising:
receiving, via a network device, at an online platform hosting a plurality of community pages, a gift recommendation request from a first user for a targeted recipient, wherein each community page is associated with a respective influential individual, and wherein each respective community page comprises a listing of items and services provided by the respective influential individual; and
based on social media data retrieved from social media pages of the targeted recipient, generating a gift recommendation for the targeted recipient.

19. The method of claim 18, further comprising:
determining based on the social media data, one or more of the respective influential individuals in which the targeted recipient has an interest; and
selecting one or more personalized items or services from the respective community pages of the one or more respective influential individuals.

20. The method of claim 18, wherein the generating is based on a geographical location of the targeted recipient, a popularity of the items and services provided by the plurality of community pages, availability of the items and services provided by the plurality of community pages, or a price of the items and services provided by the plurality of community pages.

21. A computer-implemented method comprising:
receiving, via a network device, at an online platform hosting a plurality of community pages respectively associated with influential individuals, a request for analytical data for a first community page that is associated with a first influential individual, wherein each respective community page comprises a listing of items and services provided by the respective influential individual;
in response to receiving the request, generating analytical data comprising sales data of the items and services provided on the first community page; and
based on the analytical data, determining an influence of the first influential individual.

22. The method of claim 21, wherein the request indicates a particular class of items or services, and wherein the influence of the first influential individual comprises an influence of the first influential individual selling the items and services within the particular class of items or services.

23. The method of claim 22, wherein the request further indicates a geographic area, and wherein the influence of the first influential individual further comprises an influence of the first influential individual selling the items and services within the particular class of items or services in the geographic area.
